(19) United States
(12) Patent Application Publication
(10) Pub. No.: US 2008/0180874 A1
(43) Pub. Date: Jul. 31, 2008

(54) HEADPHONE BATTERY CHARGING

(76) Inventors: Daniel M. Gauger, Cambridge, MA (US); Joji Ueda, Cambridge, MA (US)

Correspondence Address: FISH & RICHARDSON PC, P.O. BOX 1022, MINNEAPOLIS, MN, 55440-1022, US

(21) Appl. No.: 11/668,933

(22) Filed: Jan. 30, 2007

(51) Int. Cl. H01T 23/00

(52) U.S. Cl. 361/235

(57) ABSTRACT

A device for charging a headphones battery. The device includes a first module adapted to receive a first power source through a first power source connector, the first module having a connector adapted to fit the headphones battery; and a second module adapted to receive a second power source through a second power source connector, the second power source connector distinct from the first power source connector, the second module having a connector adapted to fit the headphones battery, wherein the headphones battery is removed from the headphones and charged from the first power source when the first module is connected to the headphones battery and the headphones battery is removed from the headphones and charged from the second power source when the second module is connected to the headphones battery.

### TECHNICAL FIELD

The present invention relates in general to headphones that reproduce sounds such as music, speech, or other acoustic information and more particularly concerns the electrical recharging of batteries included in headphones.

### BACKGROUND

Active noise reducing headphones generally require batteries to power electronics to which enable the headphones to generate enough energy to cancel sounds from the outside environment. Wireless headphones require batteries because there is no connection to an outside power source. It is known to use rechargeable batteries for these purposes and to recharge these batteries with a portable recharging unit that plugs into the AC mains electrical source.

### SUMMARY

In general in one aspect an apparatus for charging a headphones battery that powers a set of headphones. The apparatus includes a first module adapted to receive power from a first power source through a first power source connector, the first module having a first battery connector adapted to fit the headphones battery; and a second module adapted to receive power from a second power source through a second power source connector, the second power source connector distinct from the first power source connector, the second module having a second battery connector adapted to fit the headphones battery. The first module is constructed and arranged to recharge the headphones battery connected to the first battery connector when the first module is receiving power from the first power source, and the second module is constructed and arranged to recharge the headphones battery connected to the second battery connector when the second module is receiving power from the second power source.

Implementations may include one or more of the following features. The first power source may be characterized by a first voltage; the second power source may be characterized by a second voltage; and the first voltage may be distinct from the second voltage. The first power source may include a primary battery power source. The first power source may include an AC mains power source. The first module may include a primary battery module and the primary battery powers the primary battery module. The second module may include an AC mains module that connects to an AC mains power source. The headphones may be active noise reduction headphones or wireless headphones. The headphones battery may weigh less than 20 grams or less than 11 grams.

In another aspect, an apparatus for charging a headphones battery that powers a set of headphones includes an adaptor module. The adaptor module has a corresponding input connector and a battery connector adapted to fit the headphones battery. A first module is adapted to receive power from a first power source through a first power source connector and has a corresponding output connector adapted to fit the corresponding input connector of the adaptor module. A second module is adapted to receive power from a second power source through a second power source connector. The second power source connector is distinct from the first power source connector. The second module has a corresponding output connector adapted to fit the corresponding input connector of the adaptor module. The first module recharges the headphones battery through the adaptor module when the first module is receiving power from the first power source. The second module is recharges the headphones battery through the adaptor module when the second module is receiving power from the second power source.

The first power source may be characterized by a first voltage; the second power source may be characterized by a second voltage; and the first voltage may be distinct from the second voltage. The first power source may include a primary battery power source. The first power source may include an AC mains power source. The first module may include a primary battery module. A primary battery powers the primary battery module. The second module may include an AC mains module that connects to an AC mains power source. The headphones may be active noise reduction headphones or wireless headphones. The headphones battery may weigh less than 20 grams or less than 11 grams. The corresponding input connector and corresponding output connector may be USB connectors. The first module and the second module may have a corresponding output voltage. The corresponding output voltage may be selected from a range of 4 to 6 volts DC. There may be no substantial current drawn from the primary battery when the primary battery module is not charging the headphones battery. At least one of the modules may further include a charge rate selector for selectively adjusting charge rate as a function of power source characteristics. The charge rate selector may select a charge rate depending on whether the adaptor module is connected to the primary battery module or the AC mains module. The charge rate may be lower when the adaptor module is connected to the primary battery module than when the adaptor module is connected to the AC mains module.

In another aspect, an apparatus for charging a headphones battery includes a carrying case adapted for storage of a set of headphones, and a recharging module is integrated into the carrying case adapted for use with the headphones battery. The carrying case may include a compartment to accept primary batteries that power the recharging module.

In another aspect, an apparatus for charging a headphones battery that powers a set of headphones includes a primary battery and a primary battery module adapted for charging the headphones battery. The primary battery module contains the primary battery. The primary battery module may be disposable. The primary battery module may include a charging circuit. The headphones battery may be removable from the headphones.

In another aspect, a method of charging a headphones battery that powers a set of headphones includes selecting a first module from a plurality of available modules, each module of the plurality of modules connectable to at least one distinct power source type; connecting a first power source to the selected first module; and removing the headphones battery from the headphones and connecting it to the selected first module for recharging. The method may further include selecting a second module from the plurality of available modules, the first module distinct from the second module; connecting a second power source to the selected second module; and removing the headphones battery from the set of headphones and connecting it to the selected second module for recharging.

### BRIEF DESCRIPTION OF THE SEVERAL VIEWS OF THE DRAWING

FIG. 1 is a drawing of a pair of headphones, a carrying case, and a battery charger;

FIG. 2 is a drawing of a headphone cup and battery;

FIG. 3 is a schematic drawing of a modular charging system;

FIG. 4 is a schematic drawing of a USB connector set;

FIG. 5 is an electrical schematic drawing of an AC charging module;

FIG. 6 is an electrical schematic drawing of a primary battery module; and

FIG. 7 is an electrical schematic drawing of a rechargeable-battery charging module.

### DETAILED DESCRIPTION

The schematic drawings are not drawn to scale. The actual dimensions are as stated in the specification.

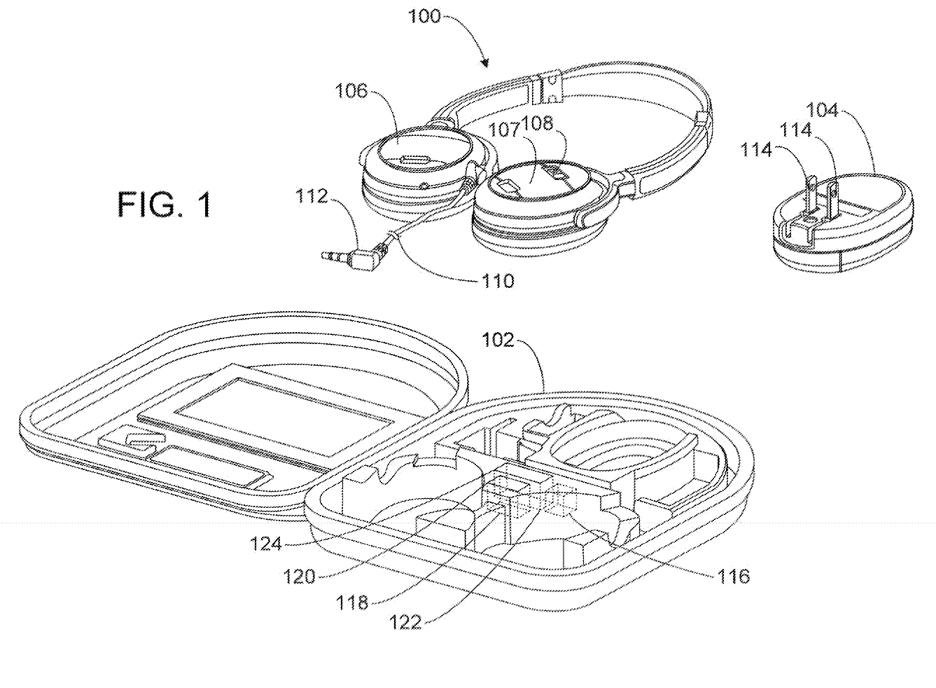

Referring to FIG. 1, there is shown a drawing of a pair of active noise canceling headphones 100, a carrying case 102, and a removable battery charger 104. The headphones 100 include earcup 106, earcup with switch and battery 107, on-off switch 108, electrical cord 110, and electrical connector 112. Removable battery charger 104 includes electrical prongs 114. The carrying case may include built-in recharging circuit 116, recharging compartment 118, recharging compartment door 120, primary battery compartment 122, and primary battery compartment door 124. The earcups 106 and 107 fit on the user's ears. Alternatively the earcups or earpieces can be designed to fit over or in the user's ears. The electrical connector 112 is plugged into a source of audio content such as a portable music player. The electrical prongs 114 are plugged into an alternating current (AC) mains electrical source such as a 110 Volt AC electrical wall socket. The headphones 100 and the removable battery charger 104 fit into the carrying case for portability and storage. The earcups 106 and 107 in FIG. 1 are shown rotated to fit into the carrying case. The optional recharging circuit 116 may substitute for the removable battery charger 104 or it may be provided in addition to the removable battery charger 104. In some embodiments, the headphones 100 may consist of only a single earcup 106 or 107 or a single earpiece that fits in the user's ears.

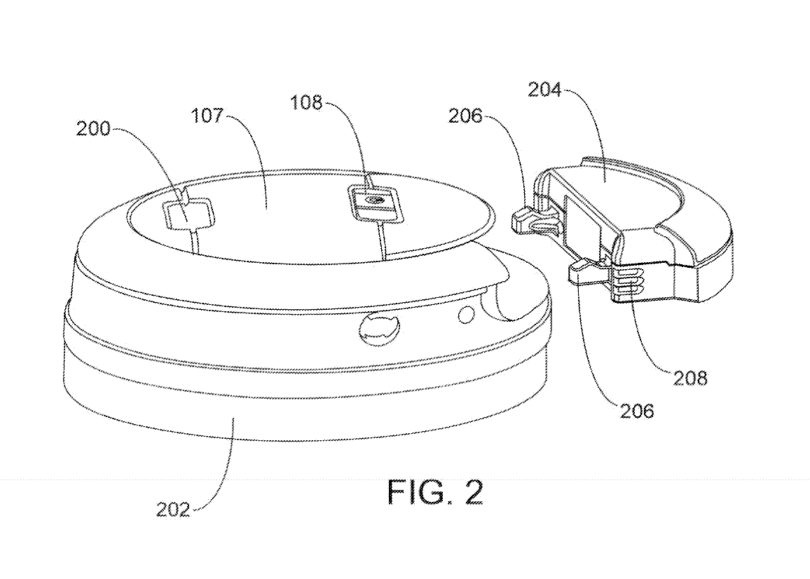

Referring to FIG. 2, there is shown a detailed drawing of the earcup 107. The earcup 107 incorporates on-off switch 108, port 200, and cushion 202. A rechargeable battery 204 plugs into the earcup 107 with a set of positioning prongs 206. The battery incorporates a set of electrical battery contacts 208. The port 200 provides improved acoustic performance according to known principles. The cushion 202 provides comfort and isolation from outside sounds in the environment. The rechargeable battery 204 provides power to headphones 100 for powering electrical circuitry such as active noise reduction circuitry, through electrical battery contacts 208. Recharging of battery 204 may also take place through electrical battery contacts 208.

Referring again to FIG. 1, the rechargeable battery 204 is inserted through the recharging compartment door 120 and into die recharging compartment 118 of case 102. Battery 204 can be charged with the recharging circuit 116. A primary battery is inserted through the primary battery compartment door 124 into the primary battery compartment 122 of case 102. In some embodiments, the primary battery provides power to recharging circuit 116, for recharging rechargeable battery 204.

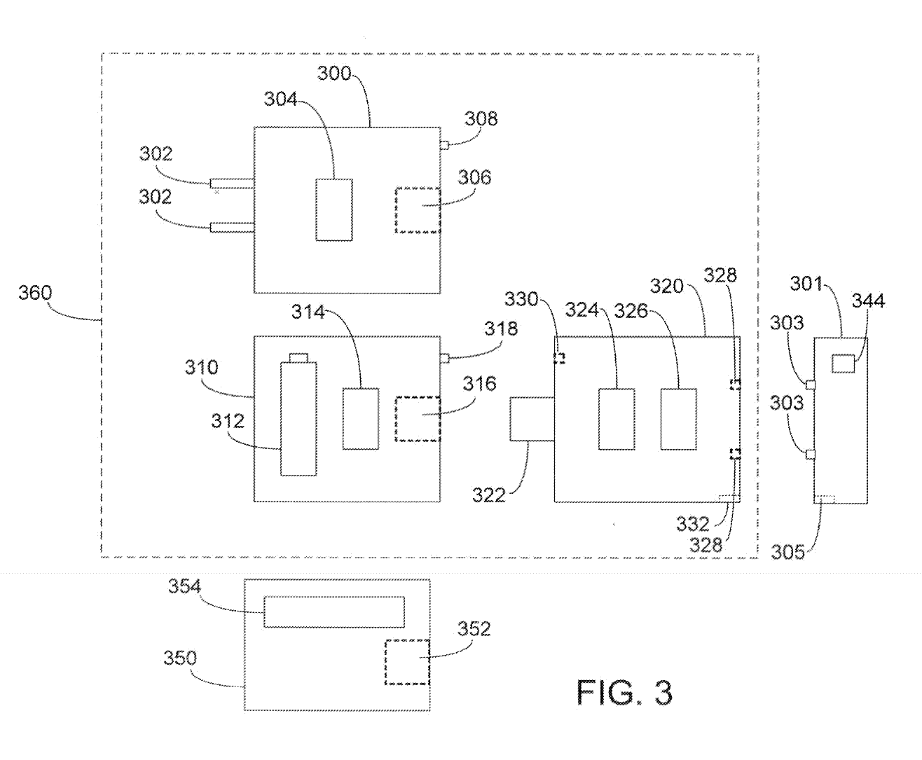

Referring to FIG. 3, there is shown a schematic drawing of a modular charging system 360. In one embodiment, the modular charging system 360 can operate in various modes that allow charging of a headphones battery from a variety of power sources such as, for example: an AC mains power supply, a primary battery, or a USB device. The modular charging system 360 includes an AC mains module 300, a primary battery module 310, and an adaptor module 320.

In FIG. 3, AC mains module 300 includes a pair of AC electrical prongs 302 for connection to AC electrical mains, AC voltage conditioning circuit 304, female (universal serial bus) USB connector 306, and sensing contact 308. Primary battery module 310 includes primary battery 312, primary voltage conditioning circuit 314, female USB connector 316, and may incorporate sensing contact 318. Rechargeable-battery charging module (also called an adaptor module) 320 includes male USB connector 322 (also called an input connector), rechargeable charging circuit 324, rate selector 326, positioning receptacles 328, electrical contacts 332, and may further incorporate sensing contact 330. Rechargeable battery 301 incorporates electrical battery contacts 305, positioning prongs 303, and a temperature sensing element 344. A computer 350 works together with the modular charging system 360 and includes a female USB connector 352 and may have an internal battery 354.

The operation of the components shown in FIG. 3 are as follows. The modular charging system 360 allows a rechargeable battery to be recharged using a number of methods. For example, it may be recharged using power provided by AC mains, by a permanent or replaceable primary cell, or by a USB connected device. Specifically, the AC electrical prongs 302 of the AC mains module 300 plug into the AC mains electrical source. The AC voltage conditioning circuit 304 converts the AC power to direct current (DC) power at 5 Volts DC which is provided to female USB connector 306. The primary battery 312 of the primary battery module 310 may be a replaceable 1.5 Volt AA-size alkaline battery or other battery commonly available. The primary battery 312 may be permanently contained in the primary battery module 310 in which ease the primary battery module 310 may be disposable. The primary voltage conditioning circuit 314 converts the primary battery voltage to a voltage which powers the female USB connector 316. The voltage may be less than the standard 5 Volts DC that is conventionally used by the USB standard. In some implementations the efficiency of primary voltage conditioning circuit 314 is dependent on the input and/or output voltage. In one embodiment when the voltage is approximately 4.2 to 4.5 Volts DC, there is a more efficient power conversion from the primary battery 312 to the rechargeable battery 301. In some implementations the primary voltage conditioning circuitry 314 is not included when the adaptor module 320 is designed to operate directly from the primary battery voltage.

Source modules consist of electrical modules that connect to various types of power sources. Each type of power source may have its own type of source module. A connector type (using complimentary connectors such as male and female connectors) is incorporated into the adaptor module 320 and corresponding connector types are incorporated in the various source modules. A source module input connector is used to bring power into a source module and an output connector that corresponds to the adaptor module input connector is used to bring power out from a source module. One type of corresponding connector is USB. In some embodiments, other types of connectors may be used. The corresponding connector type may be any type of connector that includes structures that allow power to be supplied. The AC mains module 300 and the primary battery module 310 are two types of source modules that provide power to recharge the rechargeable battery 301 through the adaptor module 320. The male USB connector 322 is a corresponding input connector on the adaptor module 320 which plugs into either the female USB connector 306 in the AC mains module 300, the female USB connector 316 in the primary battery module 310, or the female USB connector 352 in the computer 350. These female USB connectors are corresponding output connectors. The input connector type of the adaptor module may be a corresponding connector type such as USB that matches the corresponding output connector type of the source modules. The input voltage of the adaptor module is the desired voltage that the adaptor is designed to accommodate and is the voltage that matches the corresponding output voltage of the source modules. The corresponding input voltage of the adaptor module may be a voltage that fluctuates slightly within standard limits. For example, the corresponding input voltage for the adaptor module may be 5 Volts DC plus or minus 0.25 Volts DC for a USB connector. The corresponding input voltage of the adaptor module may be selected from a larger range of voltages such as 4 to 6 Volts DC. In some embodiments, there is a desired current range associated with the corresponding input voltage.

The computer 350 may be a laptop computer, or may be another computing device with a female USB connector, or may be any other portable electrical device with a female USB connector. The USB standard provides for transfer of power through pins on the connector. Instead of the computer 350, another mains powered device, with or without a battery, which has a USB port may be used as a power source that connects to the adaptor module 320.

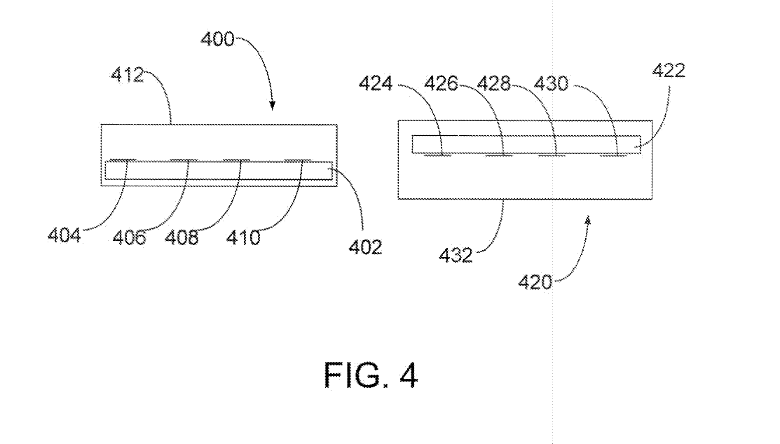

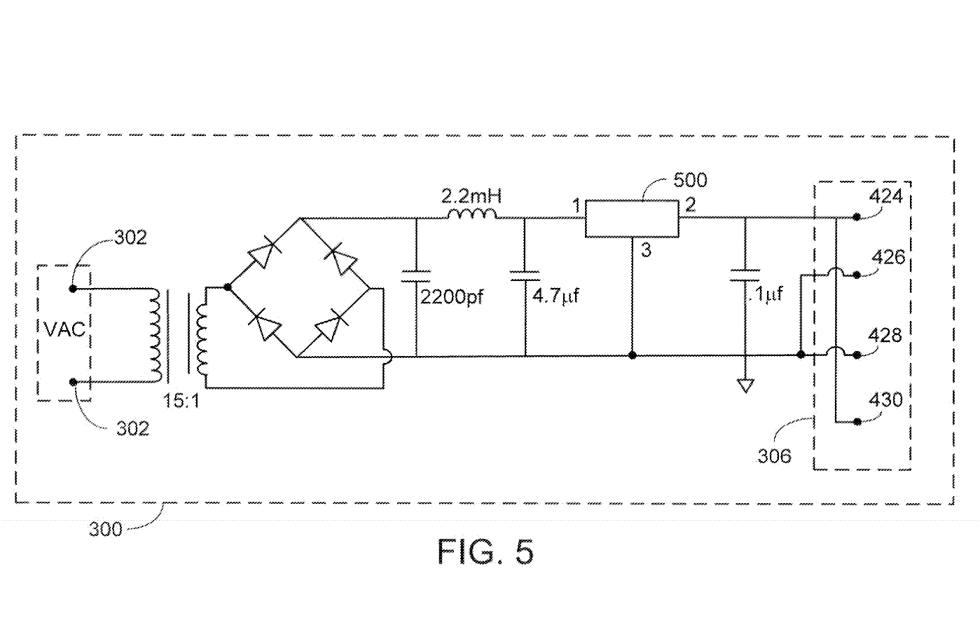

Using the USB port provides a convenient power source of known voltage and power capability, regardless of the mains power type. The charging circuit 324 converts the approximately 5 Volt DC power from the male USB connector 322 (which is the input voltage to the adaptor module) to a voltage that charges the rechargeable battery 301. According to the USB standard, female USB connector 306, 316, or 352 provides 5 Volts DC on pin 424 (shown in FIG. 4). Female USB connector 306, 316, or 352 mates to male USB connector 322 on adaptor module 320. Pin 424 on female USB connector 306, 316, or 352 connects to pin 410 on male USB connector 322 of adaptor module 320. Pin 410 conducts the power present on pin 410 to the input of charging circuit 324. Charging circuit 324 converts the 5 Volts DC present on pin 410 to a voltage suitable for charging rechargeable battery 301. One embodiment of the electrical connections is described in more detail below and shown in the electrical schematics of FIGS. 5, 6, and 7.

The charging rate of charging circuit 324 can be adapted as a function of the characteristics of the source providing power. Rate selector 326 may use the sensing contacts 308, 318 and 330 to determine which source it is connected to and to adjust the charge rate based on whether adaptor module 320 is connected to AC mains module 300, primary battery module 310, or computer 350. The rate selector 326 controls the charging rate of charging circuit 324 as described below.

Rechargeable battery 301 is removable from headphones 100 and is both mechanically and electrically coupled to adaptor module 320 while charging. Electrical contacts 305 of the rechargeable battery 301 plug into electrical contacts 332 of adaptor module 320. Electrical contacts 332 form one embodiment of a battery connector for adaptor module 320. The positioning prongs 303 plug into the positioning receptacles 328. The positioning prongs 303 are used to hold the rechargeable battery 301 into the proper position for recharging. Positioning prongs 303 are also used to align the parts when they are assembled together. In some embodiments, the battery connector may be formed into a shape that performs both the electrical connection function and the alignment function, eliminating the need for separate elements.

The temperature sensing element 344 is electrically connected to rate selector 326 through electrical battery contacts 305 and electrical contacts 332. In some embodiments, the temperature sensing element 344 is a thermistor used by the rate selector 326 to limit the charging rate of rechargeable battery 301 if rechargeable battery 301 becomes too hot.

In some embodiments the charging circuit 324 and rate selector 326 are combined into a single circuit. In some embodiments, different charging rates for the rechargeable battery 301 may be used when connected to the AC mains module 300, the primary battery module 310, and the computer 350 because energy can typically be drawn faster from the AC mains than from the primary battery 312 or the computer 350. In some embodiments, more efficient conversion of power from the primary battery 312 or computer 350 to the rechargeable battery 301 will occur when the charge rate is limited by the rate selector 326. The modular charging system 360 allows the recharger to take advantage of source characteristics so that it charge at rates that can be supported by each type of power source that is used.

The physical shape and dimensions of the electrical prongs 302 and the AC mains voltage may be different depending on the standards in each region or country. Different type's of AC mains modules 300 can be used with different AC mains standards.

In some embodiments, it is desirable to achieve at least 20 hours of portable operation from a lightweight headphone battery for noise-reducing headphones. This operation time will cover most travel purposes including airplane flights over the Pacific Ocean. By using a Lithium-Ion rechargeable battery (or equivalent) as rechargeable battery 301, primary battery module 310 and adaptor module 320, flexible charging may be achieved in a variety of circumstances while minimizing the weight and size of electronic equipment that must be carried to achieve the hours of operation desired. Because there are many options to recharge, the rechargeable battery does not require as much energy storage. For example, if a laptop or other source of USB power is available, the rechargeable battery 301 may be charged from the source of USB power. If no other power is available, the rechargeable battery 301 may be charged from the primary battery module 310.

Use of modular charging system 360 allows size and weight of the rechargeable battery and recharging circuits to be reduced while providing the possibility of recharging under a variety of circumstances (such as from sources with varying output voltages or connector types, as might be encountered in different geographical regions in the world) and with a variety of power sources (i.e., AC main power, primary batteries, secondary batteries, solar cells, fuel cells, generators (powered or hand operated) or other devices which provide a power connection, for example a computer with a USB connector, a vehicle DC power connector, etc.). Only the necessary modules for each circumstance need be brought while traveling. Modular charging system 360 is sufficiently flexible to allow charging from future types of power sources that are not currently available.

In some embodiments, the rechargeable batteries may be separable from the headphones so that multiple rechargeable batteries can be used. Enabling use of multiple rechargeable batteries allows one battery to be charged while another battery is attached to and provides power to the headphones. When the battery supplying power to the headphones is discharged, it can be exchanged for a charged battery so operation can continue. In some embodiments, the headphones do not contain recharging circuitry, which reduces the weight of the headphones.

The electrical capacity, weight, and size of the primary battery 312 and the primary battery module 310 depend on the amount of recharging desired and the capacity of the rechargeable battery 301. The total energy capacity of the rechargeable battery and primary battery determine how much energy is available to power the headphones (when the primary battery is the only source of secondary power available.) A smaller rechargeable battery may be used to minimize weight of the headphone, trading off how often the battery needs to be recharged. In some embodiments, the capacity of the rechargeable battery may be less than 400 mAh. In some embodiments, the rechargeable battery capacity may be less than 200 mAh. In some embodiments the weight of the rechargeable battery may be less than 20 g. In some embodiments the weight of the rechargeable battery may be less than 11 g.

In some embodiments, a power source module may include adaptor module circuitry and electrical battery contacts for direct connection to the rechargeable battery.

USB connectors are commonly used as data communications and electrical power connectors for electronic products such as computers, computer peripherals, user input devices, portable media devices, and portable memory storage devices. The adaptor module 320 may be plugged directly into computers or other devices with female USB connectors and the rechargeable battery 301 may be recharged from a desktop or laptop computer even when there is no AC mains power or primary battery available. In some embodiments, a cable may be used to connect between modules, between the modules and the power sources, or between the rechargeable battery 301 and the modules. In some embodiments, other connector types may be used to connect power sources to the adaptor module. For example, power source connector types may include USB connectors (both type A and B), or other equivalent connectors such as PCMCIA (Peripheral Component MicroChannel Interconnect Architecture) or IEEE (Institute of Electrical and Electronics Engineers) 1394 as well as any other connector which includes usable voltage connections. Instead of a direct electrical connection, inductive coupling may also be used. Inductive coupling uses an AC electrical voltage to transfer electrical power from one coil to another coil. The power source generates a magnetic field in a first coil which is coupled to a second coil. The second coil generates a voltage that powers the charging circuit.

Referring to FIG. 4, there is shown a section view of the connecting ends of a USB Type A connector set. A male USB connector 400 has a non-conducting substrate 402, a conducting shell 412, and electrical contacts 404, 406, 408, and 410. A female USB connector 420 has a non-conducting substrate 422, a conducting shell 432, and electrical contacts 424, 426, 428, and 430. The exterior dimensions of the male USB connector shell 412 is approximately 5 mm by 12 mm. USB connector 400 electrical contacts 404, 406, 408, and 410 are supported by substrate 402. USB connector 420 electrical contacts 424, 426, 428, and 430 are supported by the substrate 422. When the male USB connector 400 is connected to the female USB connector 420, shell 412 fits inside of and electrically connects to shell 432, substrate 402 fits next to substrate 422, contact 404 electrically connects to contact 430, contact 406 electrically connects to contact 428, contact 408 electrically connects to contact 426, and contact 410 electrically connects to contact 424. Contacts 404 and 430 are used for electrical ground, which is the return path for the USB power circuit. Contacts 406, 408, 426, and 428 may be data transfer or sensing contacts, and contacts 410 and 424 are used for 5 Volts DC power transfer. Contacts 406, 408, 426, and 428 may be used instead of or in addition to the sensing contacts 308, 318, and 330. If the USB contacts 406, 408, 426, and 428 are used instead of the sensing contacts 308, 318, and 330, the USB contacts 406, 408, 426, and 428 may use a signal to communicate between the source module 300, 310, or 350 and the adaptor module 320. The sensing contact signal or USB contact signal may be either a digital or analog signal. In some embodiments, the sensing contact signal or USB contact signal may be a simple logical high or low signal that senses the presence or absence of a specific module. The circuit diagrams described below in FIGS. 5, 6, and 7 show an example embodiment of the USB contact signal.

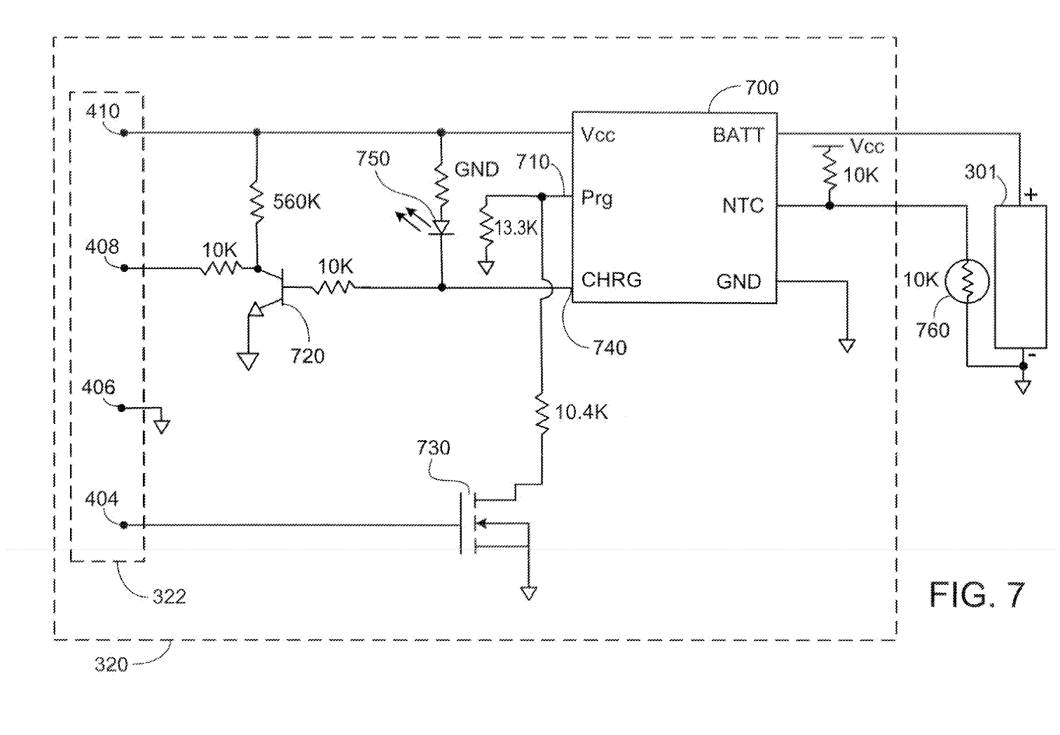

Referring to FIG. 5, there is shown an electrical schematic drawing of an example AC mains module 300. A 5-volt-regulator IC 500 converts the transformed, full-wave-rectified and filtered AC mains voltage to a regulated 5 Volts DC. The components of the AC mains module 300 includes AC electrical prongs 302, electrical contacts 424, 426, 428, 430, 5-Volt regulator integrated circuit (IC) 500, and female USB connector 306. The 5-volt-regulator IC 500 outputs 5 Volts DC to USB contact 424 of the female USB connector 306. As described in FIG. 7 below, a logical high voltage on USB contact 430 of female USB connector 306 increases the charge rate of adaptor module 320, when adaptor module 320 is connected to the AC mains module 300. In some embodiments, the signal levels present on electrical contacts of the USB connectors 306, 316, 352, and 322 are designed so that when other USB devices (such as a computer mouse) are accidentally plugged into the modules or the modules are accidentally plugged into the other devices, there is no damage to the electrical circuits of the modules or the other USB devices. According to the USB standard, the signal levels should be less than 5.25 Volts to avoid damage. The 5-volt-regulator IC 500 in this example is commercially available from National Semiconductor (Santa Clara, Calif.) as part number LM309.

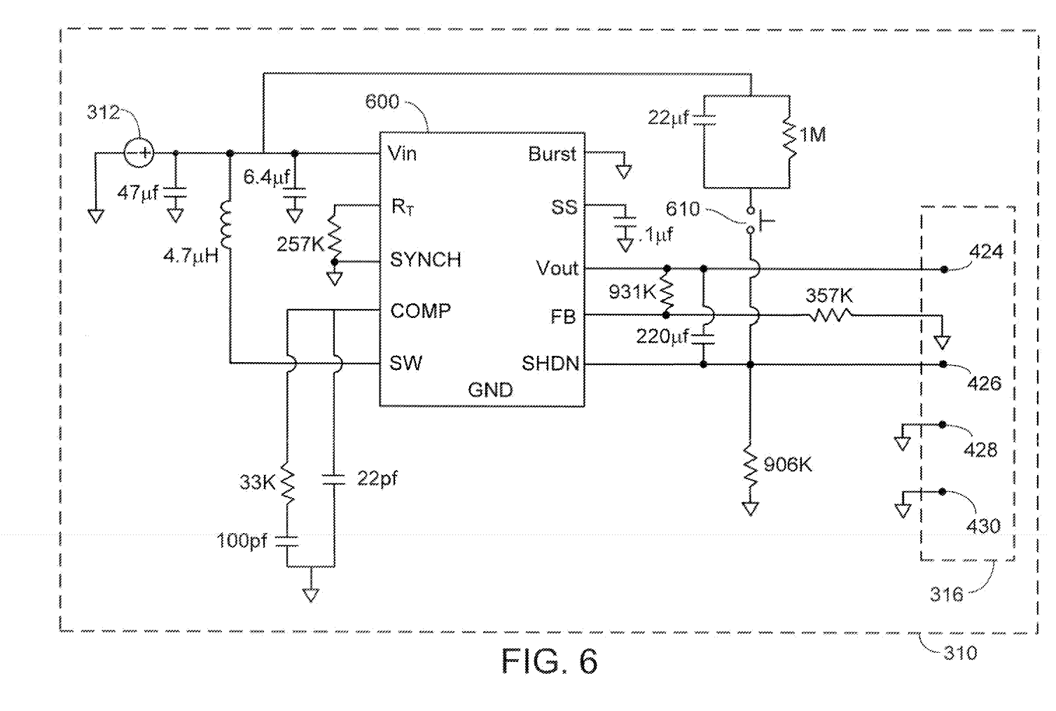

Referring to FIG. 6, there is shown an electrical schematic drawing of an example primary battery module 310. Primary battery module 310 incorporates primary battery 312, electrical contacts 424, 426, 428, 430, DC-to-DC converter IC 600, power switch 610, shutdown pin 620, and female USB connector 316. The DC-to-DC converter 600 converts the voltage from the primary battery 312 to output 5 Volts DC on contact 424 of the female USB connector 316. As described in FIG. 7 below, contact 430 of female USB connector 316 is electrically grounded to lower the charge rate of adaptor module 320. Power switch 610 is used to start the charging cycle of primary battery module 310. The power switch 610 may be a momentary switch, as shown in FIG. 6, or it may be a non-momentary switch. The DC-to-DC converter IC 600 in this example is commercially available from Linear Technology Corporation (Milpitas, Calif.) as part number LTC3422. The DC-to-DC converter IC 600 and associated circuitry draws a very low current when not being used so that it avoids discharging the primary battery 312 when the primary battery module 310 is not being used to charge the rechargeable battery 301. The maximum current draw from primary battery 312 when the headphones are not being charged may be limited to avoid premature discharge of primary battery 312 during storage. In some embodiments, primary battery module 310 incorporates more than one primary battery 312 electrically connected in series in order to raise the voltage of the primary battery assembly. In some embodiments, higher primary battery 312 voltage increases the conversion efficiency of power from primary battery 312 to the rechargeable battery 301. The size of the primary battery module 310 may be only slightly larger than the size of the primary battery 312. Primary battery 312 may be a standard AAA-size or AA-size battery. The other circuitry associated with DC-to-DC converter IC 600 is used in the conventional manner to adjust the parameters of DC-to-DC converter IC 600.

Referring to FIG. 7, there is shown an electrical schematic drawing of an example adaptor module 320. The adaptor module 320 incorporates male USB connector 322, electrical contacts 404, 406, 408, 410, Lithium-Ion battery charging IC 700, program (PRG) pin 710, NPN bipolar junction, transistor 720, field effect transistor (FET) 730, charge pin 740, charging LED 750, and thermistor 760. The voltage from contact 410 of the male USB connector 322 powers the charging IC 700 which charges the rechargeable lithium-fan battery 301. The charging rate is controlled by contact 404 of the male USB connector 322. Contact 404 of the male USB connector 322 is connected to the FET 730 which controls the program pin of the charging IC 700. When contact 404 of male USB connector 322 is grounded, the FET 730 turns off and the resistance on the program pin 710 is high. This high resistance reduces the charging rate of charging IC 700. When contact 404 of the USB connector is pulled up in voltage, FET 730 turns on, the resistance on the program pin 710 is low, and the charging rate of charging IC 700 becomes high.

When the charging of rechargeable battery 301 is finished, charging IC 700 pulls the charge pin 740 to a logical high voltage which is inverted by transistor 720 to become a logical low voltage and passes through contact 408 of the male USB connector 322 and contact 426 of the female USB connector 316 to the shutdown pin 620 of DC-to-DC converter IC 600. This switches off the primary battery module 310 to avoid draining the primary battery 312 after the charging cycle is complete. Charging LED 750 lights when the charging of rechargeable battery 301 is occurring. In some embodiments, the thermistor 760 is used by the charging IC 700 to limit the charge if the rechargeable battery 301 becomes too hot. The charging IC 700 in this example is commercially available from Linear Technology Corporation (Milpitas, Calif.) as part number LTC4069.

It is evident that those skilled in the art may now make numerous uses and modifications of and departures from the specific apparatus and techniques herein disclosed without departing from the inventive concepts. Consequently, the invention is to be construed as embracing each and every novel feature and novel combination of features present in or possessed by the apparatus and techniques herein disclosed and limited solely by the spirit and scope of the appended claims.

What is claimed is:

1. An apparatus for charging a headphones battery that powers a set of headphones, the apparatus comprising:
a first module adapted to receive power from a first power source through a first power source connector, the first module having a first battery connector adapted to fit the headphones battery; and
a second module adapted to receive power from a second power source through a second power source connector, the second power source connector distinct from the first power source connector, the second module having a second battery connector adapted to fit the headphones battery, wherein the first module is constructed and arranged to recharge the headphones battery connected to the first battery connector when the first module is receiving power from the first power source, and the second module is constructed and arranged to re-charge the headphones battery connected to the second battery connector when the second module is receiving power from the second power source.

2. An apparatus in accordance with claim 1, wherein the first power source is characterised by a first voltage, the second power source is characterized by a second voltage, and the first voltage is distinct from the second voltage.

3. An apparatus in accordance with claim 1, wherein the first power source comprises a primary battery power source.

4. An apparatus in accordance with claim 1, wherein the first power source comprises an AC mains power source.

5. An apparatus in accordance with claim 1, wherein the first module comprises a primary battery module wherein a primary battery powers the primary battery module.

6. An apparatus in accordance with claim 5, wherein the second module comprises an AC mains module that connects to an AC mains power source.

7. An apparatus in accordance with claim 1, wherein the set of headphones comprise active noise reduction headphones.

8. An apparatus in accordance with claim 1, wherein the set of headphones comprise wireless headphones.

9. An apparatus in accordance with claim 7, wherein the headphones battery weighs less than 20 grams.

10. An apparatus in accordance with claim 7, wherein the headphones battery weighs less than 11 grams.

11. An apparatus for charging a headphones battery that powers a set of headphones comprising:
an adaptor module wherein the adaptor module has a corresponding input connector and a battery connector adapted to fit the headphones battery,
a first module adapted to receive power from a first power source through a first power source connector, the first module having a corresponding output connector adapted to fit the corresponding input connector of the adaptor module; and
a second module adapted to receive power from a second power source through a second power source connector, the second power source connector distinct from the first power source connector, the second module having a corresponding output connector adapted, to fit the corresponding input connector of the adaptor module, wherein the first module is constructed and arranged to recharge the headphones battery through the adaptor module when the first module is receiving power from the first power source, and the second module is constructed and arranged to recharge the headphones battery through the adaptor module when the second module is receiving power from the second power source.

12. An apparatus in accordance with claim 11, wherein the first power source is characterised by a first voltage, the second power source is characterized by a second voltage, and the first voltage is distinct from the second voltage.

13. An apparatus in accordance with claim 11, wherein the first power source comprises a primary battery power source.

14. An apparatus in accordance with claim 11, wherein the first power source comprises an AC mains power source.

15. An apparatus in accordance with claim 11, wherein the first module comprises a primary battery module wherein a primary battery powers the primary battery module.

16. An apparatus in accordance with claim 15, wherein the second module comprises an AC mains module that connects to an AC mains power source.

17. An apparatus in accordance with claim 11, wherein the set of headphones comprise active noise reduction headphones.

18. An apparatus in accordance with claim 11, wherein the set of headphones comprise wireless headphones.

19. An apparatus in accordance with claim 11, wherein the headphones battery weighs less than 20 grams.

20. An apparatus in accordance with claim 11, wherein the headphones battery weighs less than 11 grams.

21. An apparatus in accordance with claim 11, wherein the corresponding input connector and corresponding output connector are USB connectors.

22. An apparatus in accordance with claim 11, wherein the first module and the second module have a corresponding output voltage.

23. An apparatus in accordance with claim 22, wherein the corresponding output voltage is selected from a range of 4 to 6 volts DC.

24. An apparatus in accordance with claim 11, wherein there is no substantial current drawn from the primary battery when the primary battery module is not charging the headphones battery.

25. An apparatus in accordance with claim 11 wherein at least one of the modules further comprises a charge rate selector for selectively adjusting charge rate as a function of power source characteristics.

26. An apparatus in accordance with claim 16, wherein the charge rate selector selects a charge rate depending on whether the adaptor module is connected to the primary battery module or the AC mains module.

27. An apparatus in accordance with claim 26, wherein the charge rate is lower when the adaptor module is connected to the primary battery module than when the adaptor module is connected to the AC mains module.

28. An apparatus for charging a headphones battery comprising:
a carrying case adapted for storage of a set of headphones, and
a recharging module integrated into the carrying ease adapted for use with the headphones battery.

29. An apparatus in accordance with claim 28, wherein the carrying case comprises a compartment to accept primary batteries that power the recharging module.

30. An apparatus for charging a headphones battery that powers a set of headphones, the apparatus comprising:
a primary battery, and
a primary battery module adapted for charging the headphones battery wherein the primary battery module contains the primary battery.

31. An apparatus in accordance with claim 30, wherein the primary battery module is disposable.

32. An apparatus in accordance with claim 30 wherein the primary battery module further comprises a charging circuit.

33. An apparatus in accordance with claim 30 wherein the headphones battery is removable from the set of headphones.

34. A method of charging a headphones battery that powers a set of headphones comprising:
selecting a first module from a plurality of available modules, each module of the plurality of modules connectable to at least one distinct power source type:
connecting a first power source to the selected first module; and
removing the headphones battery from the set of headphones and connecting it to the selected first module for recharging.

35. A method in accordance with claim 34 further comprising:
selecting a second module from the plurality of available modules, the first module distinct from the second module:
connecting a second power source to the selected second module; and
removing the headphones battery from the set of headphones and connecting it to the selected second module for recharging.
